(19) United States
(12) Patent Application Publication
(10) Pub. No.: US 2024/0004097 A1
(43) Pub. Date: Jan. 4, 2024

(54) Methods and Systems for Determining Parameters of Anisotropy

(71) Applicant: COMMONWEALTH SCIENTIFIC AND INDUSTRIAL RESEARCH ORGANISATION, Acton, Australian Capital Territory (AU)

(72) Inventors: Marina PERVUKHINA, Acton, Australian Capital Territory (AU); Roman BELOBORODOV, Acton, Australian Capital Territory (AU); Michael Benedict CLENNELL, Acton, Australian Capital Territory (AU); Claudio DELLE PIANE, Acton, Australian Capital Territory (AU); Yevhen KOVALYSHEN, Acton, Australian Capital Territory (AU); Valeriya SHULAKOVA, Acton, Australian Capital Territory (AU)

(73) Assignee: COMMONWEALTH SCIENTIFIC AND INDUSTRIAL RESEARCH ORGANISATION, Acton, Australian Capital Territory (AU)

(21) Appl. No.: 18/039,837

(22) PCT Filed: Dec. 14, 2021
(86) PCT No.: PCT/AU2021/051489

§ 371 Date: Jun. 1, 2023

(30) Foreign Application Priority Data
Dec. 14, 2020 (AU) 2020904652

(51) Int. Cl. G01V 1/50; G01V 1/28

(52) U.S. Cl. CPC G01V 1/50; G01V 1/284; G01V 2210/626; G01V 2210/6224; G01V 2210/6242; G01V 2210/61; G01V 2210/66

(57) ABSTRACT

Described embodiments generally relate to a method of determining parameters of VTI anisotropy of a subsurface shale formation. The method comprises receiving wireline log data relating to the subsurface formation, the data comprising density and a clay content indicator; identifying at least one layer of shale in the subsurface formation based on the wireline log data; calculating porosity, clay fraction and silt fraction based on the wireline log data; calculating an orientation distribution function (ODF) of clay platelets within the at least one layer of shale based on the clay fraction and porosity data; estimating at least three independent anisotropy parameters based on the ODF, porosity and silt fraction, the at least three anisotropic parameters comprising a shear wave anisotropy parameter; comparing the estimated shear wave anisotropy parameter with a measured shear wave anisotropy parameter determined based on the sonic log data; upon determining that the estimated shear wave anisotropy parameter is different from the measured shear wave anisotropy parameter by more than a threshold amount, determining parameters of best fit to minimise the difference between the estimated shear wave anisotropy parameter and the measured shear wave anisotropy parameter; adjusting the estimated anisotropy parameters based on the parameters of best fit; and outputting the adjusted anisotropy parameters.

### TECHNICAL FIELD

Embodiments generally relate to systems and methods for determining parameters of anisotropy of subsurface formations. In particular, embodiments relate to systems and methods for determining parameters of Vertical Transverse Isotropy (VTI) anisotropy using petrophysical data from a single vertical well.

### BACKGROUND

It is often desirable to understand the properties of subsurface formations, and the likelihood of the presence of certain rocks, minerals, oils, gases and organic matter in these formations. In some cases, imaging techniques such as seismic wave imaging can be used to view subsurface formations and determine where certain mineral and hydrocarbon deposits may be located. However, while subsurface formations are generally anisotropic and Vertical Transverse Isotropy (VTI) anisotropy is the most ubiquitous, many imaging and quantitative interpretation techniques traditionally assume an isotropic formation. Where subsurface formations exhibit VTI anisotropy, it is desirable to account for the particular anisotropy exhibited in order to correct for this when imaging the formation or performing quantitative interpretation of geophysical data. However, known methods for determining anisotropic parameters of subsurface formations tend to be time consuming, expensive and inaccurate, and lack predictive power.

It is desired to address or ameliorate one or more shortcomings or disadvantages associated with prior systems and methods for determining parameters of VTI anisotropy, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method of determining parameters of VTI anisotropy of a subsurface shale formation, the method comprising:
receiving wireline log data relating to the subsurface formation, the data comprising density and a clay content indicator;
identifying at least one layer of shale in the subsurface formation based on the wireline log data;
calculating porosity, clay fraction and silt fraction based on the wireline log data;
calculating an orientation distribution function (ODF) of clay platelets within the at least one layer of shale based on the clay fraction and porosity data;
estimating at least three independent anisotropy parameters based on the ODF, porosity and silt fraction, the at least three anisotropic parameters comprising a shear wave anisotropy parameter;
comparing the estimated shear wave anisotropy parameter with a measured shear wave anisotropy parameter determined based on the sonic log data;
upon determining that the estimated shear wave anisotropy parameter is different from the measured shear wave anisotropy parameter by more than a threshold amount, determining parameters of best fit to minimise the difference between the estimated shear wave anisotropy parameter and the measured shear wave anisotropy parameter;
adjusting the estimated anisotropy parameters based on the parameters of best fit; and
outputting the adjusted anisotropy parameters.

According to some embodiments, the received wireline log data is captured at a single vertical well.

In some embodiments, calculating the ODF comprises calculating wet clay porosity data based on the porosity and clay fraction. According to some embodiments, calculating the ODF comprises calculating compaction stage based on the wet clay porosity data, and calculating the ODF based on the compaction stage.

In some embodiments, the at least three anisotropy parameters further comprise a compressional wave anisotropic parameter, and an anellipticity anisotropy parameter.

According to some embodiments, estimating the at least three anisotropy parameters comprises calculating at least one elastic parameter. In some embodiments, calculating at least one elastic parameter comprises adjusting the elastic parameters based on a determined effect of silt in the shale formation. In some embodiments, calculating at least one elastic parameter comprises adjusting the elastic parameters based on a determined effect of porosity in the shale formation. In some embodiments, determining the effect of porosity on the shale formation is based on determining a ratio of pores within the shale formation.

According to some embodiments, calculating at least one elastic parameter comprises adjusting the elastic parameters based on a determined effect of organic matter in the shale formation.

In some embodiments, identifying a layer of shale comprises using rock physics models to perform automatic facies classification on the received data to identify shale facies of the formation. According to some embodiments, calculating the porosity, clay fraction and silt fraction comprises using the rock physics models to identify at least one shale parameter of the identified layer of shale. In some embodiments, the at least one shale parameter comprises an elastic moduli.

According to some embodiments, the rock physics models include non-linear rock physics models for compaction.

In some embodiments, the sonic log data comprises Stoneley wave velocity log data.

In some embodiments, the clay content indicator comprises at least one of gamma ray data or neutron data.

According to some embodiments, the wireline log data further comprises at least one of a compressional or shear velocity measurement.

Some embodiments relate to a method of correcting images of subsurface formations, the method comprising:

receiving an image of a subsurface formation determining a compressional wave anisotropic parameter and an anellipticity anisotropy parameter of the formation using the method of some other embodiments;

and correcting the image based on the determined parameters.

According to some embodiments, the image is captured using a seismic wave imaging technique.

### BRIEF DESCRIPTION OF DRAWINGS

Embodiments are described in further detail below, by way of example and with reference to the accompanying drawings, in which:

FIG. 1 shows a block diagram of a system for determining parameters of anisotropy according to some embodiments;

FIG. 2 shows a flowchart illustrating a method of determining parameters of anisotropy, as performed by the system of FIG. 1 according to some embodiments;

FIG. 3 shows a diagram of a core sample extracted from a subsurface formation exhibiting anisotropy;

FIGS. 4A to 4D show diagrammatic representations of areas of shale; and

FIGS. 5A and 5B show histograms illustrating the orientation distribution function of shale platelets in the shale of FIGS. 4B and 4D.

### DETAILED DESCRIPTION

Embodiments generally relate to systems and methods for determining parameters of anisotropy of subsurface formations. In particular, embodiments relate to systems and methods for determining parameters of VTI anisotropy using petrophysical data from a single vertical well.

Determining parameters of anisotropy of subsurface formations is important when imaging subsurface formations using techniques such as seismic imaging and quantitative interpretation. As seismic wave velocities exhibit angular dependence when imaging anisotropic materials, this can result in inaccuracies in the seismic imaging. Determining anisotropic layers and the parameters of anisotropy of those layers can allow for images to be corrected for the exhibited anisotropy, allowing more accurate images to be reproduced. This allows for more accurate location determination of desirable subsurface deposits, such as deposits of minerals and hydrocarbons. Accounting for the particular degree of anisotropy exhibited can also be used to sharpen imaging, recover correct formation depth, improve seismic-to-well tie and avoid drilling dry wells caused by false positive hydrocarbon identifications. Specifically, accounting for VTI anisotropy can allow for accurate quantitative interpretation including amplitude versus offset/angle (AVO/AVA) analysis to be conducted, which may result in a reduced number of false positive hydrocarbon interpretations and thus, reduce the number of drilled “dry” wells.

For example, shale is often found on top of hydrocarbons within subsurface formations, and sometimes among mineral deposits. Shales are fine-grained clastic rocks that comprise about 70% of sedimentary basins. However, shale is rarely isotropic, instead typically exhibiting from weak to significant degrees of VTI anisotropy. This anisotropy is caused by several factors, including the planar shape of clay particles within the shale and their preferential orientation within the bedding plane. The extent of the alignment of the clay particles changes with compaction and significantly depends on the amount of non-clay inclusions or silt within the shale.

When trying to locate hydrocarbons, the anisotropy of shale can prevent seismic imaging from providing accurate imaging and prevent quantitative interpretation techniques from providing accurate fluid saturation interpretation. Techniques are available to compensate for the anisotropy in anisotropic layers if the degree of anisotropy or the anisotropic parameters of the layers are known. However, in the case of vertical wells, the parameters describing the anisotropy cannot be estimated directly from logging while drilling (LWD) or wireline log data. One reason for this is that the orientation of clay particles within the shale cannot be measured directly in the process of LWD or wireline logging. Described embodiments relate to methods for determining parameters of VTI anisotropy of a subsurface shale formation when these cannot be estimated directly.

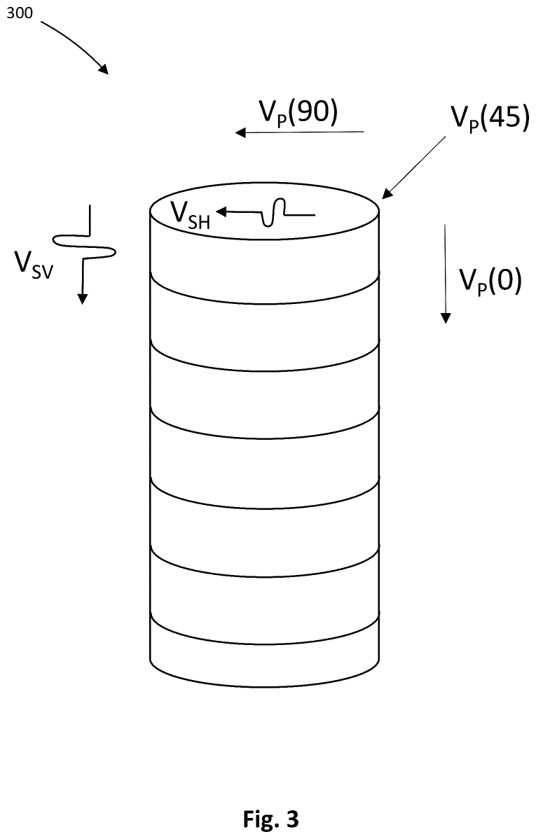

Hereafter in this document, the degree of anisotropy will be expressed in terms of Thomsen's anisotropic parameters, ε, δ, and γ, as described below in more detail with respect to FIG. 3. However, according to some embodiments, other anisotropic parameters may be used instead, as noted below with reference to FIG. 3.

One known technique for determining anisotropic parameters, such as Thomsen's anisotropic parameters ε, δ, and γ, in a particular area is to obtain a core sample, and to conduct measurements on the core sample to determine the anisotropic parameters. These measured parameters can then be extrapolated to the area from which the core sample was taken in order to correct or compensate any imaging or quantitative interpretation (such as AVO/AVA analysis results) performed in the area based on the measured anisotropy. However, this approach has a number of limitations. As the core samples are not analysed in situ, they are not necessarily representative of samples in the subsurface. Certain characteristics of the core samples may change when the core samples are removed out of the subsurface and transported to the laboratory to be measured. For example, the sample may dry out, and thin cracks that serve as discontinuities for ultrasonic wave propagation used for anisotropic parameter measurements may be introduced. This may result in inaccurate anisotropic parameter estimation. Furthermore, the measurement of the sample will only account for anisotropy on a small scale, as core samples are usually only around 3.8 cm in diameter and 5 to 10 cm in length. As anisotropy can vary over kilometres of shale formations, the sample will not be representative and will not show the change in anisotropy parameters across the entire area of those formations. As well as potentially providing inaccurate results for the reasons outlined above, the process of retrieving, transporting and properly analysing the cores can also be costly and time-consuming.

Another approach is to use vertical, horizontal and deviated wells, which may intersect the anisotropic layers, to determine anisotropy parameters by analysing the anisotropic layers directly using wireline logging or LWD. However, the places where wells penetrate shaly formations at different angles are rare if not unique, and the locations of the wells and the angles of deviation may not always be ideal for determining anisotropy. Furthermore, while walkaway vertical seismic profiling (VSP) can be used to provide more relevant and accurate data in some cases, this technique is costly and time consuming and the data may not be available, particularly when older well data is being used.

Described embodiments provide methods and systems for determining VTI anisotropic parameters based on data from a single vertical well without requiring any core samples to be taken, deviated wells to be drilled, or walkaway VSP measurements to be taken. Instead, petrophysical observations determined based on standard wireline log measurements can be used to predict the anisotropic parameters. The prediction process may use rock physics models and mathematical algorithms to simulate anisotropy caused by different reasons, and to take into account various causes of anisotropy, including the effects of the fraction of clay and silt components in the subsurface formation, the compaction stage, overpressure, the orientation distribution function (ODF) of clay platelets, porosity, cementation rate, temperature gradient, and other factors. In particular, as anisotropy within shale is linked to clay particle orientation, and since clay particle orientation is related to the compaction stage of the shale in the case of mechanical compaction, anisotropy can be estimated based on a determined aspect ratio of the strain ellipse of the clay particles within the shale. In particular, the described methods can be used where mechanical compaction with no cementation has occurred, with no clay particle transformation.

Predicted parameters can be compared to sonic log data using an iterative process to correct the parameter values until these converge with measured values. The determined parameters can then be used to correct images of the subsurface formation procured via geophysical imaging to allow the location of minerals and hydrocarbons to be determined. While described embodiments use data from seismic imaging techniques, geophysical imaging may also include gravity, magnetic or electromagnetic based surveying or imaging techniques, or ground penetrating radar techniques in some embodiments.

Use of the described methods and systems to correct geophysical images of subsurface formations can improve data processing and interpretation, leading to improved imaging and seismic-to-well ties, accurate amplitude versus offset (AVO/AVA) interpretation and more accurate seismic inversion. These outcomes are important for the purpose of resource exploration, as they result in more accurate identification of oil, gas and mineral deposit locations. The described systems and methods also result in an increase in the speed of the analysis compared with existing methods, an improvement in the success rate of accurate hydrocarbon reserve estimation, a reduction of the number of false positive hydrocarbon discoveries, and a reduction of the influence of human error and bias introduced when the task is undertaken using existing methods.

This increase in speed, cost and accuracy of imaging can be advantageously used in many industries. In the oil and gas industry, the exploration for oil and gas can be improved by more accurate identification and delineation of locations more likely to contain oil and gas. The appraisal of oil and gas fields by identification of the field extent, the quality of the reservoir and the content of fluids can also be improved, as can the monitoring of oil and gas fields in production. In the mineral resource industry, exploration for new mineral resources can be improved by allowing for more accurate mapping or delineating of an ore body or features related to the presence of recoverable mineral deposits. The appraisal of discovered mineral resources and monitoring of mining or in situ extraction can also be improved. The described systems and methods could also be advantageously used to improve geophysical imaging for the purposes of prospecting for water resources, evaluating site suitability for geological storage of CO₂, natural gas, or hydrogen, evaluating site suitability for geological containment of radioactive or other waste, characterising geotechnical and geomechanical properties of the subsurface, including pore pressure and mechanical properties, and monitoring the surroundings of a subsurface activity, among other activities. The methods and systems are application to use on the Earth, or on other astronomical bodies.

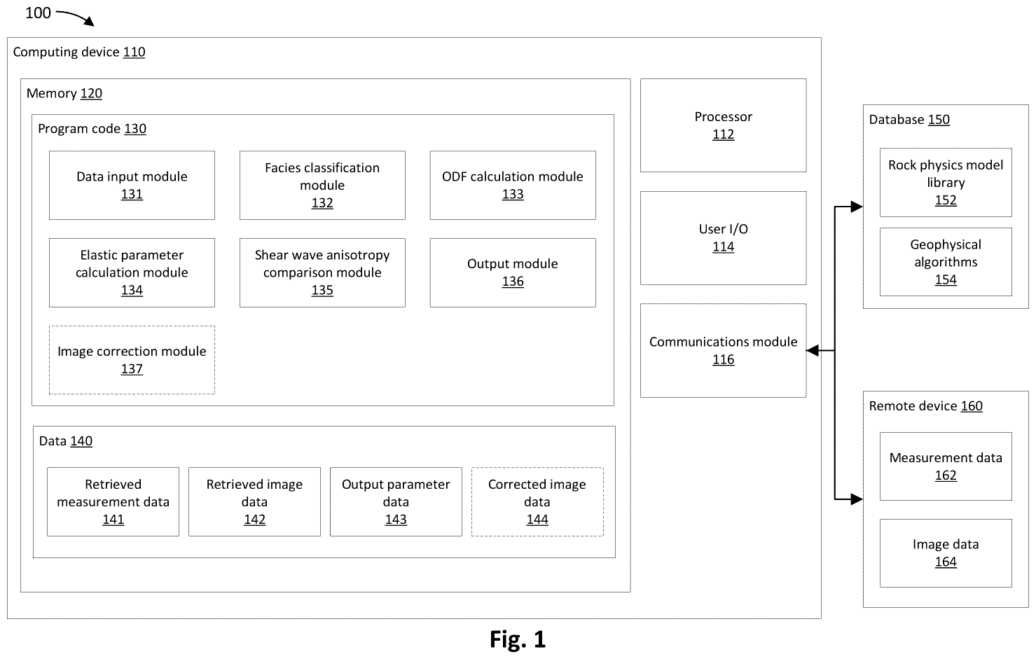

FIG. 1 shows a block diagram of a system 100 for determining anisotropy parameters according to some embodiments.

System 100 is configured to use measurements and/or data from a single vertical well to determine anisotropy parameters for a material found in the region surrounding the well. System 100 may employ an iterative method to determine the anisotropic parameters based on rock physics models and mathematical algorithms. According to some embodiments, system 100 may further use the parameters to correct image data generated based on the region surrounding the well to take into account any anisotropy exhibited in the imaged formations.

System 100 comprises a computing device 110. Computing device 110 may comprise one or more computers, servers, or other computing devices, and may be a distributed server system or a cloud based computing system in some embodiments.

Computing device 110 includes memory 120, storing program code 130 and data 140. Memory 120 may comprise one or more volatile or non-volatile memory types, such as RAM, ROM, EEPROM, or flash, for example. Computing device 110 further comprises a processor 112, which may comprise one or more microprocessors, central processing units (CPUs), application specific instruction set processors (ASIPs), or other processor capable of reading and executing instruction code. Processor 112 may be configured to access memory 120, to execute instructions stored in program code 130 and to read from and write to data 140.

Computing device 110 further includes user I/O 114, which may include one or more forms of user input and/or output devices, such as one or more of a screen, keyboard, mouse, touch screen, microphone, speaker, camera, or other device that allows information to be delivered to or received from a user. Computing device 110 may also include communications module 116. Communications module 116 may be configured to communicate with one or more external computing devices or computing systems, via a wired or wireless communication protocol. For example, communications module 116 may facilitate communication via at least one of WiFi, Bluetooth, Ethernet, USB, or via a cellular network in some embodiments.

In the illustrated embodiment, communications module 116 is in communication with a database 150 and a remote device 160. Database 150 contains rock physics model library 152. Rock physics model library 152 may comprise a library of rock physics models, which may be theoretical rock physics models, and/or empirical rock physics models, compiled based on previously measured well data. The rock physics models may include shale, mudrock, or other anisotropic rock physics models. Some rock physics models stored in rock physics model library 152 may define a relationship for at least one of the physical properties, their transformations, or combinations, to a rock burial depth for a particular rock facies, rock type, rock class. According to some embodiments, database 150 may also contain geophysical algorithms 154, which may be mathematical algorithms describing known relationships between various geophysical properties of geological materials.

Remote device 160 comprises measurement data 162 and image data 164. According to some embodiments, measurement data 162 may comprise a plurality of data points containing data relating to a subsurface formation obtained from a wireline log measurement of a vertical well. According to some embodiments, the data may include sonic well data. Measurement data 162 may comprise a multi-dimensional data set, containing data relating to more than one property for each data point. According to some embodiments, measurement data 162 may include at least density data and clay content data, such as a clay content indicator, for example. According to some embodiments, the clay content indicator may comprise gamma ray data and/or neutron data. According to some embodiments, measurement data 162 may also include compressional and shear velocity measurements.

Image data 164 may be data related to the same subsurface formation as measurement data 162. Image data 164 may be generated by seismic, gravity, magnetic or electromagnetic based surveying or imaging techniques, or ground penetrating radar techniques in some embodiments. According to some embodiments, image data 164 may be stored on a separate remote device 160 from measurement data 162.

Referring again to computing device 110, program code 130 of memory 120 may comprise a plurality of code modules executable by processor 112 to cause computing device 110 to use measurement data 162 relating to a particular subsurface formation received from remote device 160 via communications module 116 to determine anisotropy parameters of the subsurface formation using one or more models or algorithms retrieved from database 150. Knowing the anisotropy parameters of the subsurface formation may allow computing device 110 to optionally correct retrieved image data 164 relating to the subsurface formation, so that the corrected image data can be used to analyse the subsurface formation for the existence and location of hydrocarbons, minerals, and other materials.

Program code 130 may include a data input module 131, a facies classification module 132, an orientation distribution function (ODF) calculation module 133, an elastic parameter calculation module 134, a shear wave anisotropy comparison module 135, an output module 136, and optionally an image correction module 137.

When executed by processor 112, data input module 131 may be configured to receive measurement data 162 via communications module 116 as described in further detail below with reference to step 210 of method 200. According to some embodiments, processor 112 may further be configured to apply at least one form of pre-processing to the data. For example, data input module 131 may be configured to check the quality of measurement data 162.

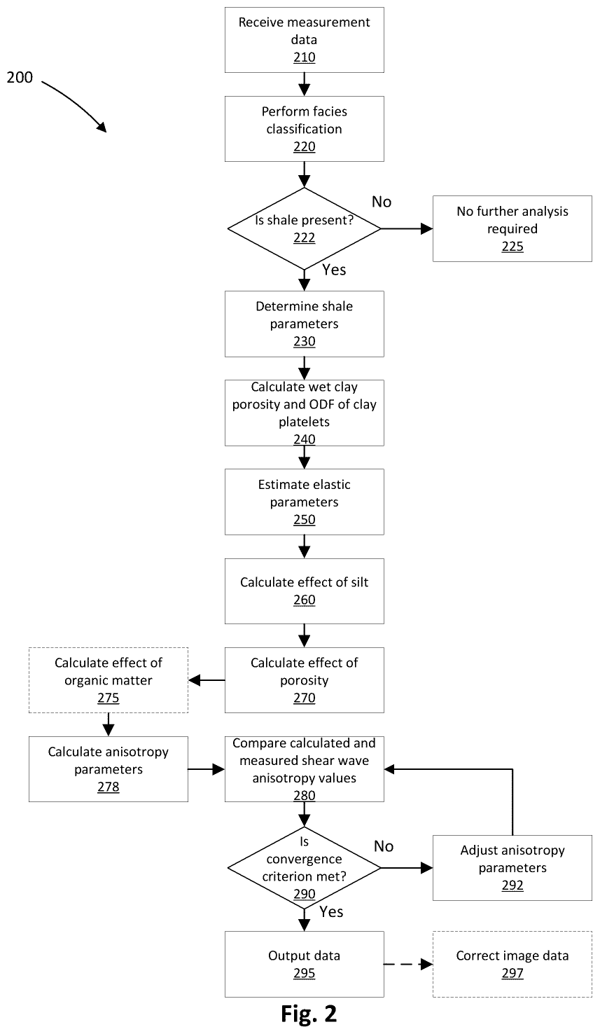

When executed by processor 112, facies classification module 132 may be configured to perform facies classification on measurement data 162, as described in further detail below with reference to steps 220, 222 and 230 of method 200 (FIG. 2).

When executed by processor 112, ODF calculation module 133 may be configured to calculate the wet clay porosity and the ODF of clay platelets in an identified region of shale based on measurement data 162, as described below in further detail with reference to step 240 of method 200.

When executed by processor 112, elastic parameter calculation module 134 may be configured to determine a number of predicted elastic parameters for the shale region, as described in further detail below with reference to steps 250, 260 and 270 of method 200.

When executed by processor 112, shear wave anisotropy comparison module 135 may be configured to determine whether the shear wave anisotropy parameter determined by elastic parameter calculation module 134 is within a predetermined threshold of a shear wave anisotropy parameter retrieved from measurement data 162, as described below with reference to steps 290 and 292 of method 200.

When executed by processor 112, output module 136 may be configured to receive the most recently predicted elastic parameters from elastic parameter calculation module 134, and to output the data to a user via user I/O 114 or to an external computing device via communications module 116.

When executed by processor 112, image correction module 137 may be configured to use the determined parameters to correct image data retrieved from image data 164 to generate corrected image data 144, and to output the corrected image data 144 to a user via user I/O 114 or to an external computing device via communications module 116

FIG. 2 shows a flowchart illustrating a method 200 of determining parameters of anisotropy performed by processor 112 of computing device 110 executing program code 130.

At step 210, processor 112 executing data input module 131 receives measurement data 162 from remote device 160 via communications module 116, and stores it locally to memory 120 as retrieved measurement data 141. As described above, measurement data 162 may include at least density data and clay content data, such as a clay content indicator. According to some embodiments, the clay content indicator may comprise gamma ray data and/or neutron data. According to some embodiments, measurement data 162 may also include compressional and shear velocity measurements. According to some embodiments, processor 112 executing data input module 131 may also receive image data 164 and store this locally to memory 120 as retrieved image data 142.

At step 220, processor 112 executing facies classification module 132 processes retrieved measurement data 141 to determine what facies are present in the subsurface formation that the measurement data corresponds to. According to some embodiments, processor 112 may perform an automatic facies classification method by comparing retrieved measurement data 141 with rock physics models retrieved from rock physics model library 152. For example, where retrieved measurement data 141 relates to an area in proximity to single vertical well that was drilled via organic-lean shale, carbonate and sandstone sequences, rock physics models for these types of rocks may be retrieved from rock physics model library 152 and used to determine the anisotropy models for these types of rock.

Rock physics models retrieved from rock physics model library 152 may include non-linear rock physics models for compaction in the statistical model for rock types, and may include depth dependent probability density functions and probabilistic classification in the Neutron porosity-density domain to describe different rock types. The facies classifications determined by processor 112 may therefore include not only separate geophysical entities, but may also attach the most likely rock physics model retrieved from rock physics model library 152 to each determined classification with corresponding fitting parameters thereby identifying a rock type.

According to some embodiments, processor 112 may perform the automatic facies classification method of step 220 by performing the method described in Australian Provisional Patent Application 2019904963, the entirety of which is herein incorporated by reference. According to some embodiments, automatic facies classification may alternatively be performed using machine learning methods, some examples of which are described in Hall and Hall, 2017, Distributed collaborative prediction: Results of the machine learning contest, which is herein incorporated by reference in its entirety. According to some alternative embodiments, automatic facies classification may be performed by a commercial software package, such as Interactive Petrophysics, which may use cluster analysis and fuzzy logic for rock typing. In some further alternative embodiments, facies classification may be performed manually, such as by an experienced petrophysicist.

At step 222, processor 112 still executing facies classification module 132 determines whether the retrieved measurement data 141 corresponds to any areas or layers of shale. Areas of shale may be defined as areas of soft, finely stratified sedimentary rock that comprises at least 30% (by volume) of clay or argillaceous material. The other constituents of shale may include silt and other different minerals, including but not limited to quartz, pyrite, feldspar and carbonates. However, the definition of shale may differ in some circumstances and may be altered by altering the rock physics model data stored in rock physics model library 152, adding a new rock physics model to rock physics model library 152, or by appropriately altering program code 130.

If processor 112 executing facies classification module 132 determines that the retrieved measurement data 141 does not correspond to any areas of shale, at step 225, processor 112 determines that as no shale is present, VTI anisotropy is negligible and no further processing to determine the anisotropic parameters is required.

If processor 112 executing facies classification module 132 determines that the retrieved measurement data 141 does correspond to at least one area or layer of shale, processor 112 still executing facies classification module 132, and having identified at least one layer of shale in the subsurface formation, proceeds to step 230. At step 230, processor 112 determines the shale parameters of the shale identified from retrieved measurement data 141, based on rock physics model data retrieved from rock physics model library 152. Shale parameters determined by processor 112 performing step 230 may include at least porosity, clay fraction and silt fraction of the shale. According to some embodiments, shale parameters may also include the elastic moduli, potential cement fraction and other rock physics parameters that can be obtained by automated facies classification.

According to some embodiments, the automatic facies classification method described in Australian Provisional Patent Application 2019904963 may be executed by processor 112 to automatically determine the shale parameters. According to some embodiments, the shale parameters may be automatically determined using a method available in a commercial software package, such as Interactive Petrophysics, for clay volume estimation. These methods can be based on gamma ray or natural radioactivity, or on neutral density separation. Details of some such methods can be found, for instance, in D. W. Ellis, J. M. Singer. Well Logging for Earth Scientists, Springer, 2008, the entirety of which is hereby incorporated by reference. According to some alternative embodiments, the shale parameters may be calculated manually, such as by an experienced petrophysicist.

Processor 112 may use rock physics methods including differential effective medium (DEM) and self-consistent approximation (SCA) methods to model the effect of the determined shale parameters in the subsurface formation, and specifically the effect of the determined shale parameters on the VTI anisotropy of the formation. Processor 112 may retrieve established relationships between shale parameters and anisotropy from rock physics model library 152 and/or geophysical algorithms 154. For example, processor 112 may retrieve a relationship stating that the fraction of non-clay component or silt reduces the degree of VTI anisotropy. In contrast, the presence of organic matter may significantly increase anisotropy, and the effect of such presence of organic matter may change at different stages of maturity of the organic matter. Processor 112 may be configured to determine maturity of detected organic matter based on petrophysical log analysis and temperature gradient data, to determine the effect of the organic matter on anisotropy of the formation. Furthermore, processor 112 may retrieve a relationship stating that porosity reduction with mechanical compaction of shale results in a noticeable increase of anisotropy, and that the porosity reduction caused by chemical compaction of shale results in an anisotropy decrease. Further relationships may include that overpressure of shale affects both porosity and anisotropy, and that the effect of overpressure on anisotropy may be taken into account via porosity variations and might require calibration.

Having determined shale parameters, at step 240 processor 112 executing ODF classification module 133 estimates the wet clay porosity of the shale and computes the orientation distribution function (ODF) of the clay platelets resulting from compaction of the shale based on the wet clay porosity. The wet clay porosity is the ratio of pore volume to the total volume of clay, where the total volume of clay is calculated as the total volume of shale minus the volume of silt (or non-clay material inclusions). Processor 112 may be configured to calculate the porosity and clay volume from wireline log data as a side product of the automated facies classification analysis. The ODF describes the direction and degree of alignment of clay platelets within the shale. Using the wet clay porosity rather than the total porosity for determining the ODF is important in order to best capture the changes of anisotropy with compaction of the shale. According to some embodiments, at step 240 processor 112 may also calculate the compaction stage of the formation, which may affect the ODF of the clay platelets.

According to some embodiments, processor 112 may use generalised spherical harmonics to determine the compaction stage.

The compaction stage may be determined by processor 112 from the wet clay porosity and the assumed wet clay porosity of a newly deposited clay using a method that describe compaction. For example, according to some embodiments, processor 112 may use Owen's formula as a compaction model for determining the compaction stage (see Owens W. H. 1973. Strain modification of angular density distributions. Tectonophysics 16, 249-261.; Baker D. W., Chawla K. S. and Krizek R. J. 1993. Compaction fabrics of pelites: experimental consolidation of kaolinite and implications for analysis of strain in slate. Journal of Structural Geology 15, 1123-1137., the contents of which are hereby incorporated by reference in their entirety). According to some alternative embodiments, the ODF may be calculated using statistical models like Gaussian, Fisher or Bingham distributions, as described in Watson G. S. 1966. The statistics of orientation data. Journal of Geology 74, 786-797.; and Johansen, T. A., B. O. Ruud, and M. Jakobsen, 2004, Effect of grain scale alignment on seismic anisotropy and reflectivity of shales: Geophysical Prospecting, 52, 133-149.; both of which are herein incorporated by reference in their entirety. According to some further alternative embodiments, the ODF may be newly derived or directly measured using neutron diffraction experiments and approximated using those measurements.

While many parameters affect elastic anisotropy of shale, including anisotropic moduli of the clay platelets, effect of silt particles, effect of pores and the effect of anisotropic distribution of organic matter, the ODF of clay platelets has a particularly strong effect on anisotropic parameters ε, γ, and δ, also called the Thomsen anisotropy parameters. The ODF of the shale can be calculated using different methods including but not limited to methods using a Gaussian function, and methods using Owens' function as described in Owens, W. H., 1973, Strain modification of angular density distributions: Tectonophysics, 16, 249-261. doi: 10.1016/0040-1951(73)90014-0, which is herein incorporated by reference in its entirety. While these functions use porosity as an input parameter to calculate strain change with compaction, in the present method, processor 112 determines the ODF by substituting the wet clay porosity (WCP) of the identified shale instead of porosity in these functions. These functions also require an initial WCP value for newly deposited shale as input. According to some embodiments, processor 112 may assume the initial WCP value to be a fixed number in the range from 0.4 to WCP is defined as a ratio of the volume of pores to the volume of clay fraction.

The volume of silt fraction is excluded from this ratio. Porosity compared to WCP is defined as a ratio of the volume of pores to the total volume of the solid fraction.

The WCP can be calculated for each depth of the formation for which retrieved measurement data 141 exists using porosity and silt fraction interpreted for each depth using the method described in Australian Provisional Patent Application 2019904963.

At step 250, processor 112 executing elastic parameter calculation module 134 is caused to estimate five elastic parameters of the clay polycrystalline material within the shale for every depth for which retrieved measurement data 141 exists. The five elastic parameters, being C₁₁, C₃₃, C₁₃, C₄₄ and C₆₆, are described in further detail below with reference to FIG. 3. The estimates may be determined by methods such as that described in Sayers, C. M., 1994, The elastic anisotropy of shales: Journal of Geophysical Research, 99, 767-774. doi: 10.1029/93JB02579., the entirety of which is herein incorporated by reference. These methods may use the ODF and five elastic coefficients of clay platelets as input parameters. In a general case, the elastic stiffnesses of a clay polycrystalline material can be calculated via direct integration using the equation:

$$〈 {c}_{ijkl} 〉 = \frac{1}{2 π} {\int }_{0}^{2 π} f ( θ ) {c}_{ijkl}^{′} ( θ , φ , ψ ) sin θ d θ .$$

Here, f(θ) is the ODF, θ is an angle between the symmetry axis and the normal to the clay platelet, and c′ᵢⱼₖₗ(θ, φ, ψ) are elastic stiffnesses of an individual clay platelet. The four subscripts of the elastic stiffness tensors can be reduced to two subscripts used above as follows (known as Voigt's notation): 11->1; 22->2; 33->3; 23,32->4; 31,13->5; 21,12->6.

According to some embodiments, the elastic properties of clay platelets may be approximated by processor 112 using first-principles calculation of the elastic moduli of sheet silicates (see, for example, Militzer, B., H. R. Wenk, S. Stackhouse, and L. Stixrude, 2011, First-principles calculation of the elastic moduli of sheet silicates and their application to shale anisotropy: American Mineralogist, 96, no. 1, 125-137. doi: 10.2138/Am.2011.3558., the entirety of which is herein incorporated by reference). In other embodiments, the elastic properties of clay platelets may be approximated by processor 112 using elastic properties of clay platelets derived via equivalent TI medium (see Sayers, C. M. and den Boer, L. D., The Elastic Properties of Clay in Shales, Journal of Geophysical Research: Solid Earth, 2018, 10.1029/2018JB015600, which is herein incorporated by reference in its entirety).

In estimating the elastic parameters, the properties of anisotropic clay platelets are assumed to be in the range of physically plausible values. While the elastic properties of clay platelets can vary by orders of magnitude, the range of anisotropic parameters will be mostly determined by the ODF of clay platelets and not by the anisotropy of a single clay platelet. Based on this, and as clay platelets have a preferred orientation when they settle or precipitate which causes anisotropy, elasticity can be determined for the whole body of the identified shale including the clay platelets using these methods.

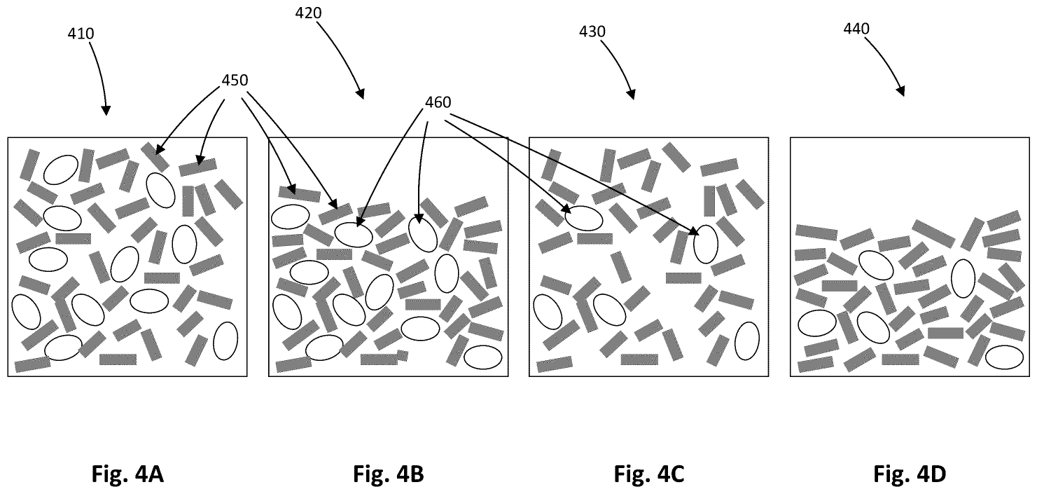

At step 260, processor 112 still executing elastic parameter calculation module 134 calculates the effect of silt on the elastic parameters determined at step 250. Silt may include quartz, pyrite, hydrocarbons and other known non-clay inclusions within the identified body of shale. According to some embodiments, processor 112 may use anisotropic effective medium models or theories to determine the effect of silt on the elastic parameters, which may include but are not limited to the method suggested by Nishizawa, O., 1982, Seismic velocity anisotropy in a medium containing oriented cracks—transversely isotropic case: Journal of Physics of the Earth, 30, no. 4, 331-347, doi: 10.4294/jpe1952.30.331. (Nishizawa), the entirety of which is incorporated herein by reference. According to some embodiments, the effects of silt may be taken into account via Self-Consistent Approximation (SCA). According to some further embodiments, the effects of porosity may be taken into account using the method described in Sevostianov, I, Yilmaz N., Kushch V., Levin V., Effective properties of matrix composites with transversely-isotropic phases, International Journal of Solids and Structures, 2005, 455-476, the contents of which are herein incorporated by reference in their entirety. The silt fraction, aspect ratio and the elastic properties of silt inclusions may be used as input for these methods. Fixed plausible aspect ratios of silt inclusions obtained from analysis of microtomographic images or thin sections may be used for these methods in some embodiments. In other embodiments, a number of different aspect ratios or a continuous distribution of aspect ratios of silt inclusions obtained from analysis of microtomographic images or thin sections can be used as an input for these methods. The elastic parameters determined at step 250 may be adjusted by processor 112 based on the determined effect. According to some embodiments, the effect of silt fraction may also be used by processor 112 when determining the ODF of clay platelets in its clay fraction, as described above with reference to step 240, as described below with reference to FIG. 4.

At step 270, processor 112 still executing elastic parameter calculation module 134 also calculates the effect of porosity of the shale on the elastic parameters determined at step 260. According to some embodiments, processor 112 may use anisotropic effective medium models or theories to determine the effect of porosity on the elastic parameters, which may include but are not limited to the method suggested by Nishizawa. According to some embodiments, the effects of porosity may be taken into account via Self-Consistent Approximation (SCA). According to some further embodiments, the effects of porosity may be taken into account using the method described in Sevostianov, I, Yilmaz N., Kushch V., Levin V., Effective properties of matrix composites with transversely-isotropic phases, International Journal of Solids and Structures, 2005, 455-476, the contents of which are herein incorporated by reference in their entirety. These methods may require the aspect ratio and elastic properties of pore filling fluids to be provided as input. According to some embodiments, processor 112 may calculate the effect of porosity based on the assumption that the aspect ratios of pores within the shale are in the range of 0.5-0.7. This assumption may be based on direct measurements on natural shales as described in Desbois, G., J. L. Urai, and P. A. Kukla, 2009, Morphology of the pore space in claystones—evidence from BIB/FIB ion beam sectioning and cryo-SEM observations: eEarth, 4, 15-22., the entirety of which is herein incorporated by reference. The range of plausible aspect ratios of fluid inclusions can be extended if new evidence comes to light. While the aspect ratio of pores is generally only used as a fitting parameter, the present method uses this aspect ratio to determine the effect of porosity on the elastic parameters of the shale. The elastic parameters determined at step 250 may be adjusted by processor 112 based on the determined effect. Elastic properties of pore filling fluids that might be represented by brine, oil, gas or their mixtures might vary significantly depending on in situ conditions, especially pressure and temperature. Specific elastic properties can be calculated by processor 112 based on the information provided in handbooks or reference books (including but not limited to Ellis, D. W., Singer, J. M. Well Logging for Earth Scientists, Springer, 2008; Rock Physics & Phase Relations, A handbook of Physical Constants, Editor Ahrens, T. J., 1995, for example, the contents of which is hereby incorporated by reference in its entirety).

According to some embodiments, processor 112 may also execute optional step 275. In particular, processor 112 may be configured to execute optional step 275 where processor 112 determines that the shale contains organic matter. Processor 112 may determine that the shale contains organic matter based on input received by processor 112 via user I/O 114, or based on previous calculations performed by processor 112 derived from the measurement data 162. If processor 112 determines that no organic matter is present in the shale, then processor 112 proceeds from step 270 to step 280. If processor 112 determines that there is organic matter in the shale, then at step 275 processor 112 still executing elastic parameter calculation module 134 calculates the effect of organic matter within the shale on the elastic parameters determined at step 250.

The effect of organic matter on the elastic properties of shales can be accounted for by processor 112 using any appropriate method. For example, according to some embodiments, the effect of organic matter on the elastic properties of shales can be accounted for using the methods described in Pervukhina, M., Gurevich, B., Dewhurst, D., Golodonuic P., Lebedev, M., 2015, Rock physics of shale reservoirs, in Fundamentals of Gas Shale Reservoirs, John Wiley & Sons, Edited by R. Rezaee, ISBN 978-1-118-64579-6, the contents of which are herein incorporated by reference in their entirety. Alternatively, the effect of organic matter on the elastic properties of shales can be taken into account using the method described in Sayers, C. M. (2013a). The effect of kerogen on the elastic anisotropy of organic-rich shales. Geophysics 78(2): D65-D74, the contents of which are herein incorporated by reference in their entirety. Alternatively, the effect of organic matter on the elastic properties of shales can be accounted for using the method described in Vernik, L. and X. Z. Liu (1997). Velocity anisotropy in shales: A petrophysical study. Geophysics 62(2): 521-532. and Vernik, L. and A. Nur (1992). Ultrasonic Velocity and Anisotropy of Hydrocarbon Source Rocks. Geophysics 57(5): 727-735, the contents of which are herein incorporated by reference in their entirety.

Together with V_{P}(0) and V_{SV} which can be measured in a vertical well, the calculated Thomsen anisotropy parameters ε, γ, and δ comprise all the five independent anisotropic parameters of a TI medium. These parameters are described in further detail below with reference to FIG. 3.

At step 278, at least three independent anisotropy parameters, which may be the Thomsen anisotropy parameters ε, γ, and δ, can then be calculated. According to some embodiments, these parameters may be calculated based on the previously determined ODF, porosity and silt fraction. According to some embodiments, these parameters are calculated as described in Thomsen, L., 1986, Weak elastic anisotropy: Geophysics, 51, no. 10, 1954-1966, doi: 10.1190/1.1442051., the entirety of which is incorporated herein by reference. As described in further detail with reference to FIG. 3, the Thomsen anisotropy parameters ε, γ, and δ can be calculated based on the five elastic coefficients C₁₁, C₃₃, C₁₃, C₄₄ and C₆₆ which are derivable based on the ODF, porosity and silt fraction. The calculated Thomsen anisotropy parameters ε, γ, and δ are hereafter called the modelled anisotropic parameters.

At step 280, processor 112 executing shear wave anisotropy comparison module is caused to compare modelled anisotropic parameter γ, being the shear wave anisotropy parameter, against a measured shear wave anisotropy parameter γ. Specifically, processor 112 may be configured to compare the modelled anisotropic parameter γ with a benchmark γ determined based on wireline sonic log data, which may be Stoneley wave velocity log data in some embodiments, to determine how accurate the modelled anisotropic parameters are. The wireline log data may be read by processor 112 from retrieved measurement data 141. Where Stoneley wave data is not available or not recoverable, processor 112 may skip step 290, and proceed to step 295 by outputting the modelled anisotropic parameters as determined at step 270 or 275.

At step 290, processor 112 still executing shear wave anisotropy comparison module 135 determines whether the modelled anisotropic parameter γ is within a predetermined threshold of the measured shear wave anisotropy parameter γ.

If the modelled anisotropic parameter γ is not within a predetermined threshold of the measured shear wave anisotropy parameter γ, then at step 292 processor 112 still executing shear wave anisotropy comparison module 135 uses contact properties to match the values of the modelled anisotropic parameter γ with the measured shear wave anisotropy parameter γ. This may be done by minimising the misfit between the measured and predicted shear wave anisotropy parameter γ. Processor 112 may then use the parameters of the best fit as determined by minimising the misfit to calculate adjusted ε and δ parameters. Once these adjusted parameters are calculated, processor 112 may return to step 280, re-comparing the adjusted value with the measured shear wave anisotropy parameter γ. Method 200 may then be repeated iteratively, with the WCP of newly deposited shale and the anisotropic parameters of clay platelets acting as fitting parameters.

If at step 290 processor 112 determines that the modelled γ differs from the measured γ by less than the predetermined threshold amount, then the modelled ε, γ, and δ parameters are assumed to cover the correct range of anisotropic parameters. At step 295, processor 112 executing output module 136 then stores the modelled parameters as output parameter data 143, and outputs the modelled parameters to a user via user I/O 114 or to an external computing device via communications module 116, to allow the modelled parameters to be used to correct image data.

At optional step 297, processor 112 executing image correction module 137 may use the output parameters data 143 to correct retrieved image data 142 to produce corrected image data 144. Corrected image data 144 may take into account the anisotropic properties of the imaged materials, and correct for these properties to produce a more accurate image that can be used to identify and locate various hydrocarbons, minerals and other materials.

FIG. 3 shows a diagrammatic representation of a layered subsurface formation 300, being a TI medium, to illustrated the elastic and anisotropic parameters determined by processor 112 executing method 200. FIG. 3 shows the compressional wave velocity V_{P} measured in three directions, being parallel to the symmetry axis (V_{P}(0)), perpendicular to the symmetry axis (V_{P}(90)) and at 45 degrees to the symmetry axis (V_{P}(45)). FIG. 3 also shows two shear velocities, being a shear wave velocity propagating along the symmetry axis (V_{SV}), and a shear wave velocity propagating perpendicular to the symmetry axis and polarized in the bedding plane, Val.

As described above with reference to FIG. 2, processor 112 executing elastic parameter calculation module 134 is configured to calculate five elastic coefficients in order to characterise a TI medium such as formation 300. These five elastic coefficients are referred to as C₁₁, C₃₃, C₁₃, C₄₄ and C₆₆. The equations used to derive them are:

$${C}_{11} = ρ {V}_{P}^{2} ( 9 {0}^{∘} )$$

$${C}_{33} = ρ {V}_{P}^{2} ( {0}^{∘} )$$

$${C}_{44} = ρ {V}_{SV}^{2} ( {0}^{∘} )$$

$${C}_{66} = ρ {V}_{SH}^{2} ( 9 {0}^{∘} )$$

$${C}_{13} = - {C}_{44} + \sqrt{4 {ρ}^{2} {V}_{P}^{4} ( 4 {5}^{∘} ) - 2 ρ {V}_{P}^{2} ( 4 {5}^{∘} ) ( {C}_{11} + {C}_{33} + 2 {C}_{44} ) + ( {C}_{11} + {C}_{44} ) ( {C}_{33} + {C}_{44} )}$$

These elastic parameters can in turn be used to calculate the Thomsen anisotropy parameters, which are an alternative way to describe a TI medium such as formation 300. The Thomsen anisotropy parameters comprise a P-wave or compressional wave anisotropic parameter ε, an S-wave or shear wave anisotropic parameter γ, and an anellipticity parameter δ (see Thomsen, L., 1986, Weak elastic anisotropy: Geophysics, Soc. of Expl. Geophys., 51, 1954-1966, the entirety of which is herein incorporated by reference). These three parameters together with elastic parameters C₃₃ and C₄₄ (or V_{P}(0) and V_{SV}) can also be used to fully characterize a TI medium. The equations used to derive the Thomsen anisotropy parameters are:

$$ε = \frac{{C}_{11} - {C}_{33}}{2 {C}_{33}}$$

$$γ = \frac{{C}_{66} - {C}_{44}}{2 {C}_{44}}$$

$$δ = \frac{{( {C}_{13} + {C}_{44} )}^{2} - {( {C}_{33} - {C}_{44} )}^{2}}{2 {C}_{33} ( {C}_{33} - {C}_{44} )}$$

According to some embodiments, parameters can be used instead of the Thomsen anisotropy parameters to define the anisotropy in a TI medium. According to some embodiments, one alternative parameter that may be used is the anellipticity parameter η (see Alkhalifah, T., Tsvankin, I. 1995. Velocity analysis for transversely isotropic media. Geophysics 60, 1550-1566, herein incorporated by reference in its entirety). Another alternative parameter that may be used is the SV-wave moveout parameter σ. The equations used to derive these alternative parameters are:

$$η = \frac{ε - δ}{1 + 2 δ}$$

$$σ = \frac{{C}_{33}}{{C}_{44}} ( ε - δ )$$

According to some embodiments, any other suitable anisotropy parameters that can be used to describe a TI medium may be used (see, for instance, Schoenberg, M. and Muir, F., 1989, A calculus for finely layered anisotropic media: Geophysics, Soc. of Expl. Geophys., 54, 581-589, herein incorporated by reference in its entirety).

FIGS. 4A to 4D show diagrammatic representations 410, 420, 430 and 440 of shale, and the effect of silt on the ODF of clay platelets. Shale platelets 450 are represented as grey bars, while silt particles 460 are represented as open ovals.

FIG. 4A shows a schematic representation 410 of shale in an initially deposited state.

FIG. 4B shows a schematic representation 420 of the shale of FIG. 4A in a mechanically compacted state, such as after the shale has had time to settle.

FIG. 4C shows a schematic representation 430 of a different shale in an initially deposited state. Compared to FIGS. 4A and 4B, the shale of FIG. 4C has a reduced silt fraction.

FIG. 4D shows a schematic representation 440 of the shale of FIG. 4C in a mechanically compacted state, such as after the shale has had time to settle.

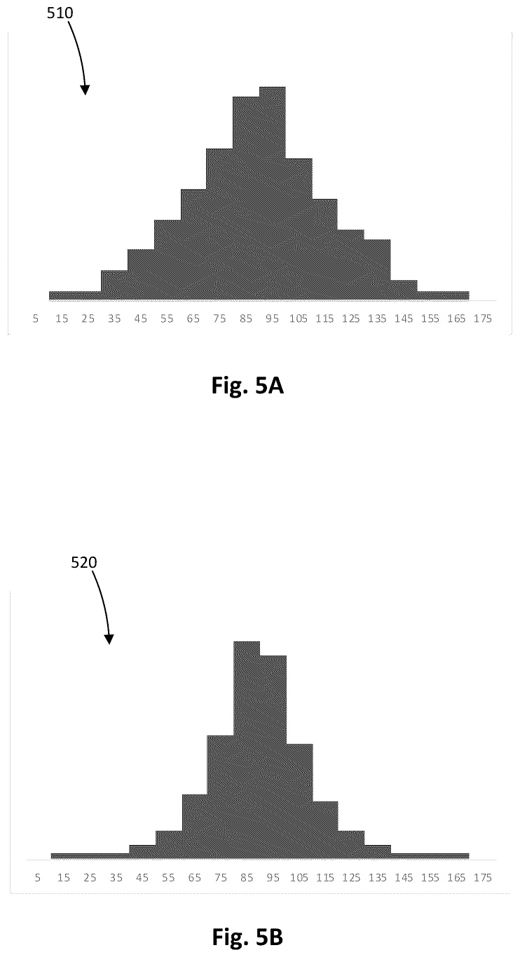

FIGS. 5A and 5B show histograms 510 and 520 that illustrate the approximate ODF of shale platelets for the compaction states shown in FIGS. 4B and 4D, respectively. Where the silt fraction is smaller, such as in FIGS. 4C and 4D, the clay particles 450 are more aligned in the bedding plane, causing a narrower range of ODF values, as shown in FIG. 5B, with the ODF of the majority of shale platelets falling between 65° and 115°. The increase of silt fraction illustrated in FIGS. 4A and 4B results in a broader ODF, with the majority spread between 45° and 135°, as illustrated in FIG. 5A. This result is confirmed by the results of compaction experiments described in Beloborodov, R., Pervukhina, M., Luzin, V., Delle Piane, C., Clennell, M. B., Zandi, S. and Lebedev, M., 2016. Compaction of quartz-kaolinite mixtures: The influence of the pore fluid composition on the development of their microstructure and elastic anisotropy. Marine and Petroleum Geology, 78, pp. 426-438, the contents of which are herein incorporated by reference in their entirety.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of determining parameters of VTI anisotropy of a subsurface shale formation, the method comprising:
receiving wireline log data relating to the subsurface formation, the data comprising density and a clay content indicator;
identifying at least one layer of shale in the subsurface formation based on the wireline log data;
calculating porosity, clay fraction and silt fraction based on the wireline log data;
calculating an orientation distribution function (ODF) of clay platelets within the at least one layer of shale based on the clay fraction and porosity data;
estimating at least three independent anisotropy parameters based on the ODF, porosity and silt fraction, the at least three anisotropic parameters comprising a shear wave anisotropy parameter;
comparing the estimated shear wave anisotropy parameter with a measured shear wave anisotropy parameter determined based on the sonic log data;
upon determining that the estimated shear wave anisotropy parameter is different from the measured shear wave anisotropy parameter by more than a threshold amount, determining parameters of best fit to minimise the difference between the estimated shear wave anisotropy parameter and the measured shear wave anisotropy parameter;
adjusting the estimated anisotropy parameters based on the parameters of best fit; and
outputting the adjusted anisotropy parameters.

2. The method of claim 1, wherein the received wireline log data is captured at a single vertical well.

3. The method of claim 1, wherein calculating the ODF comprises calculating wet clay porosity data based on the porosity and clay fraction.

4. The method of claim 3, wherein calculating the ODF comprises calculating a compaction stage based on the wet clay porosity data, and calculating the ODF based on the compaction stage.

5. The method of claim 1, wherein the at least three anisotropy parameters further comprise a compressional wave anisotropic parameter, and an anellipticity anisotropy parameter.

6. The method of claim 1, wherein estimating the at least three anisotropy parameters comprises calculating at least one elastic parameter.

7. The method of claim 6, wherein calculating at least one elastic parameter comprises adjusting the elastic parameters based on a determined effect of silt in the shale formation.

8. The method of claim 6, wherein calculating at least one elastic parameter comprises adjusting the elastic parameters based on a determined effect of porosity in the shale formation.

9. The method of claim 8, wherein determining the effect of porosity on the shale formation is based on determining a ratio of pores within the shale formation.

10. The method of claim 6, wherein calculating at least one elastic parameter comprises adjusting the elastic parameters based on a determined effect of organic matter in the shale formation.

11. The method of claim 1, wherein identifying a layer of shale comprises using rock physics models to perform automatic facies classification on the received data to identify shale facies of the formation.

12. The method of claim 11, wherein calculating the porosity, clay fraction and silt fraction comprises using the rock physics models to identify at least one shale parameter of the identified layer of shale.

13. The method of claim 12, wherein the at least one shale parameter comprises an elastic moduli.

14. The method of claim 11, wherein the rock physics models include non-linear rock physics models for compaction.

15. The method of claim 1, wherein the sonic log data comprises Stoneley wave velocity log data.

16. The method of claim 1, wherein the clay content indicator comprises at least one of gamma ray data or neutron data.

17. The method of claim 1, wherein the wireline log data further comprises at least one of a compressional or shear velocity measurement.

18. A method of correcting images of subsurface formations, the method comprising:
receiving an image of a subsurface formation;
determining a compressional wave anisotropic parameter and an anellipticity anisotropy parameter of the formation using the method of claim 1; and
correcting the image based on the determined parameters.

19. The method of claim 18, wherein the image is captured using a seismic wave imaging technique.

20. (canceled)

21. A non-transitory computer-readable medium storing executable program code that, when executed by a computing device or computing system, causes the computing device or computing system to perform the method according to claim 1.
